(19) United States
(12) Patent Application Publication
(10) Pub. No.: US 2021/0166399 A1
(43) Pub. Date: Jun. 3, 2021

(54) Background Balancing in a Collection of Digital Images

(71) Applicant: EyeQ Imaging Inc., Calgary (CA)

(72) Inventors: Jeffrey Stephens, Austin, TX (US); Yelena Sholokhova, San Francisco, CA (US); Anton Maslov, Calgary (CA)

(21) Appl. No.: 17/070,905

(22) Filed: Oct. 14, 2020

Related U.S. Application Data
(60) Provisional application No. 62/915,015, filed on Oct. 14, 2019.
(60) Provisional application No. 62/963,028, filed on Jan. 18, 2020.
(60) Provisional application No. 62/964,601, filed on Jan. 22, 2020.

(51) Int. Cl. G06T 7/194; G06T 7/00; G06T 5/00; G06T 5/50; G06T 5/20

(52) U.S. Cl. CPC G06T 7/194; G06T 7/97; G06T 5/20; G06T 5/50; G06T 5/008

(57) ABSTRACT

A presentation is assembled of a collection of digital images that include different foreground objects against background regions. A target value of an image parameter for the background regions is determined statistically from captured background region image data of the collection. The background region of each image in the collection is adjusted to uniformly exhibit a value of the image parameter that is within a narrow range of values around a statistically ascertained target value.

### PRIORITY

This application claims the benefit of priority to U.S. provisional patent application Ser. Nos. 62/915,015 filed Oct. 14, 2019, 62/963,028 filed Jan. 18, 2020 and 62/964,601, filed Jan. 22, 2020, and each is incorporated by reference.

### BACKGROUND OF THE INVENTION

### 1. Field of the Invention

The present invention relates to digital cameras and digital image processing solutions, and particularly for compilation and presentation of image collections and camera enabled digital devices configured for image capturing and processing, and storing and rendering presentations of image collections including foreground objects against uniform backgrounds.

### 2. Description of the Related Art

For some applications the ability to provide foreground/background separation in an image is useful. In PCT published application, WO2007/025578, separation based on an analysis of a flash and non-flash version of an image is discussed. However, there are situations where flash and non-flash versions of an image may not provide sufficient discrimination, e.g. in bright sunlight.

Depth from de-focus is a well-known image processing technique which creates a depth map from two or more images with different focal lengths. A summary of this technique can be found at: http://homepages.inf.ed.ac.uk/rbf/CVonline/LOCAL_COPIES/FAVARO1/dfdtutorial.html. Favaro is based on a statistical analysis of radiance of two or more images—each out of focus—to determine depth of features in an image. Favaro is based on knowing that blurring of a pixel corresponds with a given Gaussian convolution kernel and so applying an inverse convolution indicates the extent of defocus of a pixel and this in turn can be used to construct a depth map. Favaro requires a dedicated approach to depth calculation once images have been acquired in that a separate radiance map must be created for each image used in depth calculations. This represents a substantial additional processing overhead compared to the existing image acquisition process.

US 2003/0052991, Hewlett-Packard, discloses for each of a series of images taken at different focus distances, building a contrast map for each pixel based on a product of the difference in pixel brightness surrounding a pixel. The greater the product of brightness differences, the more likely a pixel is considered to be in focus. The image with the greatest contrast levels for a pixel is taken to indicate the distance of the pixel from the viewfinder. This enables the camera to build a depth map for a scene. The camera application then implements a simulated fill flash based on the distance information. Here, the contrast map needs to be built especially and again represents a substantial additional processing overhead over the existing image acquisition process.

US 2004/0076335, Epson, describes a method for low depth of field image segmentation. Epson is based on knowing that sharply focused regions contain high frequency components. US 2003/0219172, Philips, discloses calculating the sharpness of a single image according to the Kurtosis (shape of distribution) of its Discrete Cosine Transform (DCT) coefficients. US 2004/0120598, Xiao-Fan Feng, also discloses using the DCT blocks of a single image to detect blur within the image. Each of Epson, Philips and Feng is based on analysis of a single image and cannot reliably distinguish between foreground and background regions of an image.

Other prior art includes US 2003/0091225 which describes creating a depth map from two “stereo” images.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A-1D illustrate photographs that include portrait images of four different persons against respectively abstract, non-uniform backgrounds that vary in brightness, color, and other image parameters.

FIGS. 2A-2B illustrate a background mask, respectively, before and after refining the mask in accordance with an example embodiment to remove islands and fill lakes on opposite sides of mask edge segments.

FIGS. 3A-3B illustrate a background mask after refining in accordance with the example embodiment of FIG. 2B, respectively, before and after applying a gradient mask that decreases an amount of adjusting of background pixels from the top of the image to the bottom of the image in accordance with an example embodiment.

FIGS. 4A-4D illustrate a collection of four portrait images of four different persons whose faces and clothing are dark and differ in brightness and color against backgrounds that differ in brightness and color.

FIGS. 5A-5D illustrate the collection of images of FIGS. 4A-4D that have been adjusted to brighten the faces and clothing of the four photographed persons, while the backgrounds vary greatly in brightness and color.

FIGS. 6A-6D illustrate the collection of images of FIGS. 5A-5D that have each been adjusted so that each background region matches the same or nearly the same target values of exposure, hue and saturation in accordance with an example embodiment.

FIG. 7A-7D illustrate the collection of images of FIGS. 5A-5D that have each been adjusted so that differences in exposure, hue and saturation between each background region and target values have been reduced by smaller amounts than in FIGS. 6A-6D in accordance with another example embodiment.

FIGS. 8A-8D illustrate the collection of images of FIGS. 7A-7D that have been adjusted so that the backgrounds are progressively darkened from FIG. 8A to FIG. 8B to FIG. 8C to FIG. 8D in accordance with an example embodiment.

FIG. 9 is flow diagram that illustrates a method of assembling a presentation that includes a collection of digital images each include a foreground portrait, face or other object against a background that has been adjusted to uniformly exhibit a target value of an image parameter in accordance with an example embodiment.

FIG. 10 is a flow diagram that illustrates a method of processing a collection of portrait images including creating a background region mask for segmenting a background region from a foreground object of each image and adjusting the background region to uniformly exhibit a target value of an image parameter in accordance with an example embodiment.

FIG. 11 illustrates a block diagram showing examples of options for adjusting background regions of each image in a collection so that the image parameter of FIGS. 10 and 11 uniformly match either exactly or within a reduced percentage or fraction of a target value of an image parameter in accordance with an example embodiment.

FIG. 12 illustrates steps of determining average values of an image parameter in background regions of multiple images in a collection and determining a target background statistical value of the image parameter over all of a subset of the background regions within the multiple images in the collection in accordance with certain embodiments.

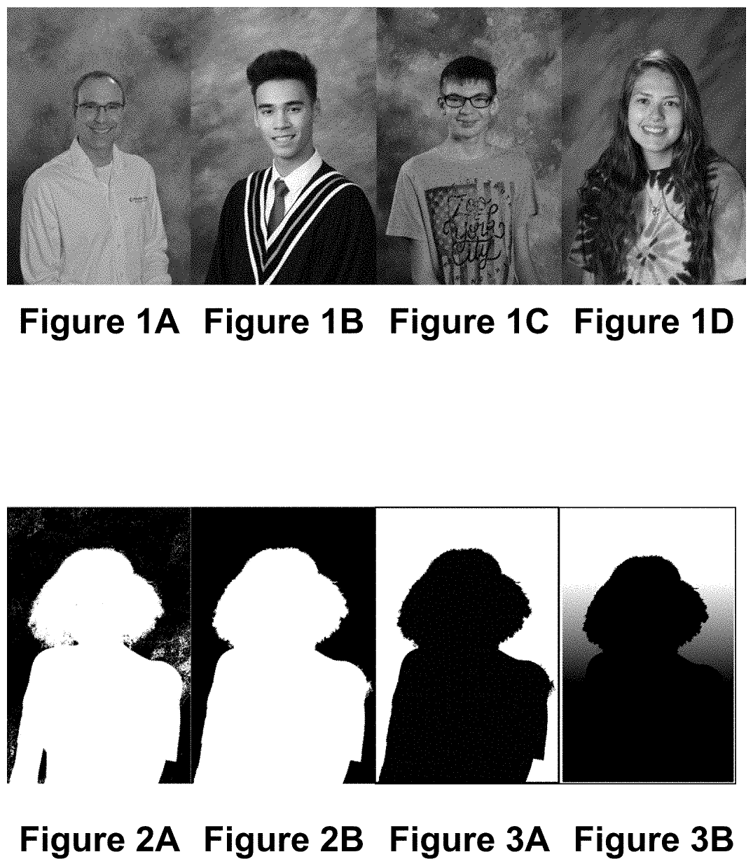

### DETAILED DESCRIPTION OF THE EMBODIMENTS

A method is provided in accordance with an example embodiment for generating a collection of digital images including different foreground faces, portraits or other objects set against background regions. The background region data for an image parameter (e.g., exposure, luminance, brightness, and/or hue, tint, chrominance or color) or multiple image parameters (e.g., brightness and hue or brightness, hue and saturation) or a combination of image parameters of each image in the collection are adjusted to a same or approximately same or similar target value that is derived statistically from the background region data from multiple images in the collection. The adjusted background image data may include an average value of an image parameter that differs from the target value by a reduced difference amount compared with the original captured background image data. Difference ratios between different images in the collection may be substantially maintained in an example embodiment, while those differences between the adjusted values of the image parameter and the target value may be reduced by a percentage amount or the standard deviation for the collection may be reduced significantly to render more visually uniform the background regions of the adjusted images in the collection. Multiple image parameters may be reduced in their variance with average values as target values for each image in the collection.

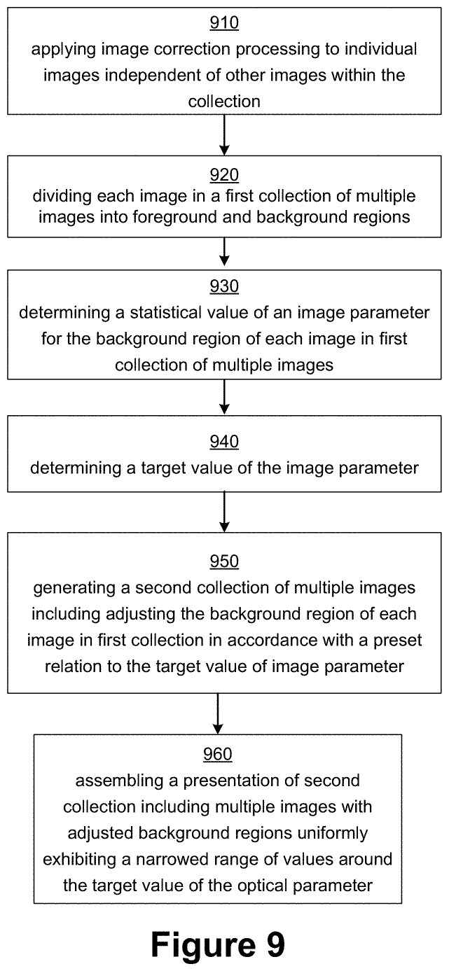

FIG. 9 illustrates an example process that includes at step 910 a step of applying image correction processing to individual images of a first collection independent of other images within the collection. Then at step 920, the example processor-implemented method of FIG. 9 includes dividing each image in the first collection of multiple images into foreground and background regions. At Step 930, a statistical mean, median or mode average value of an image parameter may be determined for the background region of each image in the first collection of multiple images. At Step 940, a target value of the image parameter may be determined, e.g., as a statistical mean, median or mode average value of the image parameter, for all or a subset or sub-sampling of the multiple images in the collection. At Step 950, a second collection of multiple images that include adjusted background region data from those of said first collection may differ in values of an image parameter in accordance with a preset relation to the target value of said image parameter. At Step 960, a presentation of the second collection may clearly include multiple images with adjusted background regions uniformly exhibiting a significantly narrowed range of values around the target value of the image parameter.

One or more non-transitory processor-readable storage devices may be provided in an example embodiment that have code embedded therein for programming a processor to perform a method of generating a collection of digital images of different foreground objects against background regions adjusted from captured image data for uniformly exhibiting approximately a same average target value of an image parameter. Each image in a first collection of multiple images may be divided into foreground and background regions. A statistical value of an image parameter may be determined for the background region of each image in the first collection of multiple images. A target value of the image parameter may be determined as a statistical mean, median or mode average or other statistical calculation based on multiple images in the first collection. A second collection of multiple images may be generated including adjusted average values of one or more image parameters in the background region data of each image in the first collection. The adjusted value of the image parameter may be calculated for some or all of the images in the collection as being identical to the target value or in accordance with another preset relation to the target value of the image parameter.

A presentation of the second collection may be assembled that includes multiple images with adjusted background regions uniformly exhibiting a narrowed range of average values for the image parameter around the target value of the image parameter.

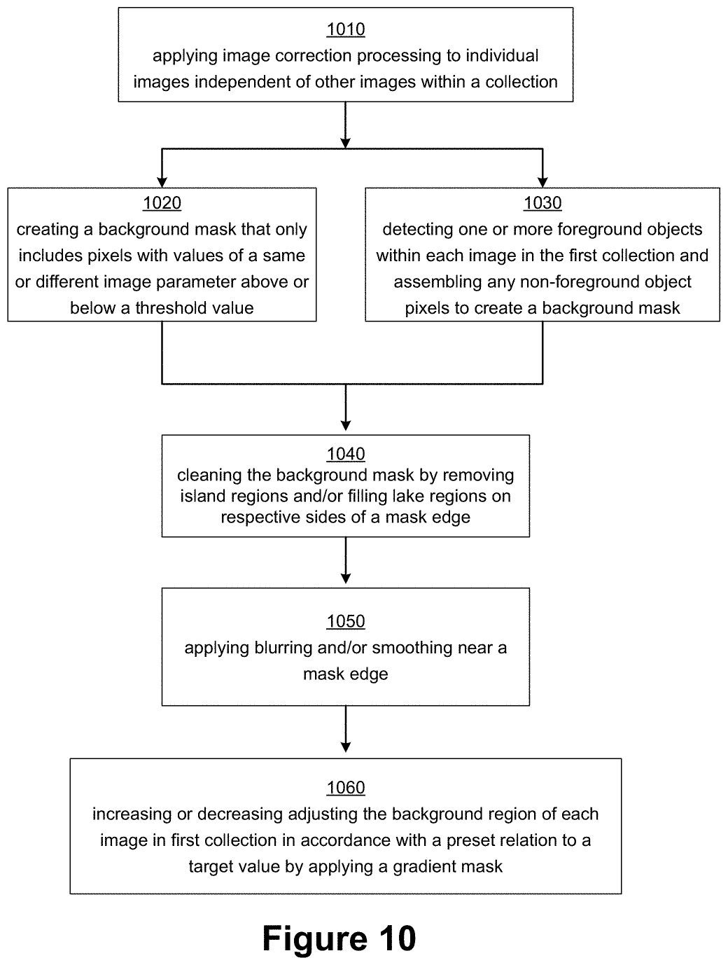

FIG. 10 illustrates an example process that includes at step 1010 a step of applying image correction processing to individual images of a first collection independent of other images within the collection. Then at step 1020, the dividing of an image into foreground and background regions may include creating a background mask that only includes pixels with values of a same or different image parameter above or below a threshold value.

At step 1030, the example method of FIG. 10 includes at step 1030, an alternative to step 1020, that includes detecting one or more foreground objects within each image in the collection and designating any non-foreground object pixels as background. That is, in FIG. 10, Step 1030, the dividing of an image into foreground and background regions may include in example embodiments detecting one or more foreground objects within each image in the first collection and designating any pixels that are not foreground pixels forming a foreground object to be background pixels forming said background region.

At Step 1040, the creating of the background mask may include cleaning the background mask by removing island regions or filling lake regions or both on respective sides of a mask edge or a boundary with the foreground region. At step 1050 in the method of FIG. 10, a step of applying blurring or smoothing or both to background regions of images in the collection that are near a mask edge.

In FIG. 10, at step 1060, an example method may include increasing or decreasing the adjusting of the background region of each image in the first collection in accordance with the preset relation to the target value by applying a gradient mask along a straight or curved length in a constant direction or in a constantly changing direction, or combinations thereof, within the image plane.

The preset relation may be an exact match or an exact variance or a difference reduction or in an exact difference ratio with one or more other images in the collection, or combination thereof.

The adjusting in accordance with the preset relation may include reducing an initial difference between values of the background region and the target value to within a predetermined percentage of the initial difference, such as 50%, 40%, 30%, 25%, 20%, 15%, 10%, 8%, 6%, 5%, 4%, 3%, 2.5%, 2%, 1.5%, 1%, 0.5%, 0.4%, 0.3%, 0.2%, 0.1% or 0.01%.

The adjusting in accordance with the preset relation may include reducing an initial difference between values of the background region and the target value to within a predetermined range of smaller differences compared with the initial difference.

The adjusting in accordance with the preset relation may in certain embodiments include reducing an initial difference between values of the background region and the target value by a predetermined percentage of the initial difference.

In another example embodiment, the method may include adjusting the foreground region of each image in the collection by a fraction of an amount of the adjusting of the background region.

In FIG. 10, Step 1010, the collection of multiple images may include images processed by applying image correction processing to individual images independent of other images within the collection.

The determining of the target value may include determining an average value of the image parameter for all or a sub-sampling of the background regions within image in the collection. The determining of the target value may include setting the target value as an average value or as an adjusted value based on the average value.

In FIG. 10, Step 1050, a method in accordance with an example embodiment may include applying blurring or smoothing or both to background regions of images in the collection that are near a mask edge.

The statistical value of the image parameter may include an average brightness, average brightness range, average dynamic range, standard deviation from average brightness, average hue, hue distribution, average saturation, saturation distribution, a noise pattern, a texture pattern, average sharpness, average focus, average blur, average lighting gradient, lighting distribution, average dynamic range, or specific color channel subsets thereof, or combinations thereof.

The statistical value of the image parameter may include one or more average relational intensities of multiple color channels. The adjusting of the background regions may exclude one or more color channels and/or may include one or more color channels.

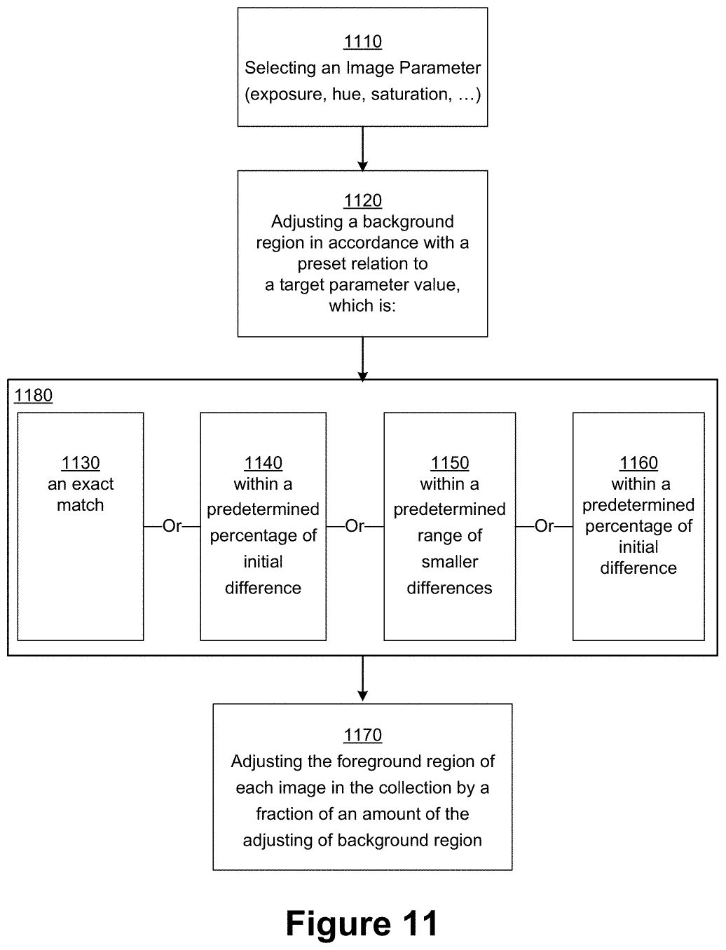

The generating of the second collection may include adjusting the background regions in accordance with preset relations to target values of multiple image parameters. The multiple image parameters may include average exposure, hue and saturation or combination of two of these image parameters at set forth at step 1110 in FIG. 11.

A camera enabled digital device in accordance with an example embodiment may include a device housing, a lens, an image sensor disposed at a focal plane of the lens, a processor and one or more processor-readable storage devices having code embedded therein for programming the processor to perform a method of generating a collection of digital images of different foreground objects against background regions adjusted from captured image data to match or more nearly match an average value of a statistical sample of background regions within images in the collection or a value of an image not in the collection, or another target value of a background region image parameter. The collection of digital images with adjusted background image data, in accordance with step 1120 of FIG. 11, of multiple images matching a same target value of an image parameter may exhibit a more uniform, orderly or conforming appearance or collective identity compared to the original image collection with respect to the image parameter.

A difference between an average value of an image parameter in a background region of an image in a collection and a target value, e.g., an average value, of the image parameter characterizing all, or a uniform subset, of all of the background regions in a second image collection that includes a processed version of the first image collection. The second image collection includes a set or a subset of images that share a high degree or enhanced level of collective identity, parameter-specific uniformity, homogeneity and/or similarity of group appearance that is not shared by any subsets of images in the first image collection. The enhanced uniformity of background regions of images in the second collection has been generated by applying independent individual adjustments to each image in the first collection. Each independently determined adjustment amount applied to images of the first collection to obtain the second collection may be based on a representative median or mode image selected from the first collection or on a statistically calculated value based on averaging a subset or group of multiple images of the first image collection in example embodiments. Alternatively, one or more reference images that are not taken directly from the first image collection may be used to determine advantageous and relevant background adjustments for images in the first collection to form a new collection of images that share background regions that have a collective attribute in common and/or exhibit some uniformity with regard to at least one mage parameter. Examples of such reference images include relatively low resolution preview and/or post-view images, different images in a stream, sequence or series of images or subsampled versions of images in the first collection, or processed or combined versions of images one or more of which may be selected from the first collection of images, or images of a different image collection that share a common characteristic such as similar type of event, same photographer or photographic school or artistic genre, a same location of different events, a same advertiser or sponsor, a similar outdoor weather condition or many same participating persons or groups of persons.

Differences between images in a first collection may be reduced in accordance with any of the example steps illustrated at 1180 in FIG. 11. The image parameter may be adjusted in a first collection image to exactly match a target value illustrated in step 1130 of FIG. 11, or the initial difference may be reduced to within a predetermined percentage of the initial difference, as shown in step 1140, or within a predetermined range of smaller differences as indicated at step 1150 of FIG. 11, or within a predetermined percentage of the initial difference per step 1160, or combinations of these. The method of claim 11 may also include optionally at step 1170 adjusting the value of the image parameter in the foreground region of each image in the collection by a fraction of an amount of adjusting of the image parameter applied to the background region, and alternatively a second image parameter may be adjusted in the foreground regions of images in a collection by amounts that are calculated based on amounts of adjustment of the first image parameter that are applied to the background regions of these images.

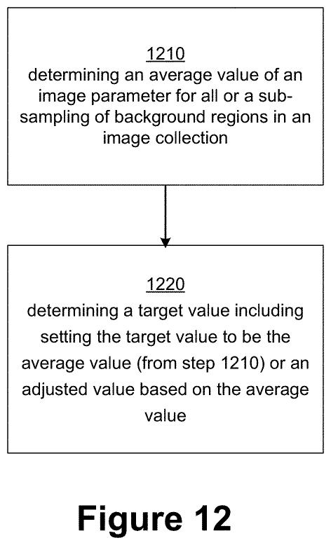

An example embodiment of a process that may be performed with a camera-enabled digital device in accordance with example embodiments may include capturing a first collection of multiple images; dividing each image in the first collection of multiple images into foreground and background regions; determining a statistical value of an image parameter for the background region of each image in the first collection of multiple images as set forth at step 1210 in FIG. 12; and determining a target value of the image parameter as set forth at step 1220 of FIG. 12; generating a second collection of multiple images including adjusting the background region of each image in the first collection in accordance with a preset relation to the target value of the image parameter as set forth at step 1220 of FIG. 12; and assembling a presentation of the second collection that includes multiple images with adjusted background regions uniformly exhibiting a narrowed range of values around a target value of an image parameter or a different optical or digital parameter associated with the first image collection or a predetermined theme that is not a parameter associated with optically-generated images such as may represent personal mental images or dreams, myths, collective images, creative descriptors of abstract appearance art or naturally occurring phenomena, human conditions, common experiences or feelings or abstract thoughts or Jungian archtypes.

In an example embodiment, a collection of images grouped together as a collection or as a job or as a shoot may be equalized, calibrated, normalized, conformed with or to, diversified or homogenized, identified collectively, harmonized or rendered uniform or similar in a certain region of the image and either not all or not as much in another region of the image. Also, the certain region that is equalized, etc., may, in one example embodiment, only be equalized, etc., in its value of a particular image parameter or in its values of more than one and less than all image parameters, such that certain image parameters may not be equalized, etc., across the images of a collection. By modifying the backgrounds of images to match a target value for at least one image parameter, the backgrounds are rendered more uniformly as to that at least one image parameter, thus making the backgrounds visually identical or varied by an orderly process of applying controlled adjustments of selected image parameters of selected regions of images in the collection. An immediate example application for such usage may be a collection of class or school portraits.

A process in accordance with an example embodiment may include the following steps:

1. Correcting each image in a collection of multiple images individually to looks its best (for example using Eyeq's Perfectly-Clear® corrections);

2. Segmenting each image into foreground and background areas;

3. Determining individual background statistics values for each image in the collection;

4. Determining a target background statistics value for the entire collection;

5. Altering the background of each image in the collection so that it's adjusted background statistics value is visually identical or nearly identical or within a narrowed range of values around the target value for the entire collection of images rendering the backgrounds of images in the collection substantially uniform in one or more image parameters.

In another example embodiment, a processor may be programmed to perform the following steps in a process or subsets thereof.

1. Determining individual background statistics for each photographic image in a collection of multiple portrait images;

2. Determining a target background statistics for the job including the collection of multiple photographic portrait images;

3. Creating a mask to separate a person in the foreground from the background;

4. Making a mask for each image in the collection using value thresholding on one or more imaging criteria;

5. Cleaning each mask so that each image contains one foreground object surrounded by a continuous sea of background;

6. Optionally, Applying Gradient Mask;

7. Optionally, blurring and/or softening the mask;

8. Applying a Bias or adjustment to the correction parameters;

9: Adjusting image backgrounds of each image in the collection to match the target background statistics determined in step 2 above.

A method in accordance with an example embodiment may include steps 1, 2 and 9 after separating a background region from a foreground region in multiple images of a collection of portrait images and/or other images containing one or more face regions and a background region.

Another method in accordance with an example embodiment may include steps 1, 2, 8 and 9 after separating a background region from a foreground region in multiple images of a collection of portrait images and/or other images containing one or more face regions and a background region.

In another example embodiment, a yearbook may be assembled. In certain pages of the yearbook, images including student portraits, groups of students together in group photos, and/or various photos of student sharing a collective identity such as class year, an activity such as a sport, a club, a class trip, a stage production, a classroom activity, a homecoming, a prom, a graduation, a holiday event, or other such event, activity or student, parent or faculty group memorialized in a collection of multiple photographic images may be assembled together on a same page or on adjacent or consecutive pages. The multiple images in any such collection of photos may be adjusted to have more uniform background regions that may be collectively identified together whether indicative of the particular event, group or activity, etc., that the photos in the collection share in common or only rendered visually similar. For example, the images in a collection that share a common identifying characteristic event, activity, club, sport or otherwise may have their background regions rendered with one or more uniform if not identical image parameters, such that the backgrounds of images in the collection are adjusted to be more similar in appearance than the original captured image data showed. The adjusted background regions in several example embodiments do not include identical sets of pixel data, but are rendered to feel the same or similar and/or to appear to have some collective identity, uniformity and/or unique style or texture or pattern of exposure intensity and/or color distribution and/or other identifiably common, collective and/or uniform image parameter value grouping.

In another example embodiment, headshots for passport photos and other identification or ID cards may be made with backgrounds that are non-distracting and meet the requirements of the passport agency or ID card provider. In example embodiments, the background regions may be adjusted to share an uniform neutral color and/or a bright color that is perhaps even close to pure white.

In another example embodiment, pre-processing is provided for images shot on greenscreens for chromakey processing to make the images easier to process by, for example in one embodiment, ensuring that all backgrounds in a collection are equally bright and set to a specific green hue and saturation. Differences in lighting and exposure values at the time a photo is taken can result in images containing different shades of greens.

In other example embodiments, collections of images that are different in content may be adjusted so that the images appear to share a more uniform background appearance or collective identity. That is, the spirit and scope of the invention may be applied both to similar content image collections and to different content image collections. The multiple images in a collection that are different in content may nonetheless each be adjusted to conform to a certain average value or target value of an image parameter. In this example embodiment, similar process steps may be taken for balancing collections of same-content images and for balancing collections of images that are different in content. Examples include collages, general photobook uses, controlling photobook page-to-page transitions and video image streams and clips.

A collage may be assembled as a collection of images printed on a same output platform, such as on posters, blankets, thematic web sites or web pages, magazines, newspapers and stylized publications and/or other canvases where the intention is to create or assemble a collection of images with a uniform look-and-feel.

In an example embodiment involving general photobook use, multiple images may be balanced together on a single page. In fact, any multi-image presentation such as photobooks or printed collages may be enhanced in accordance with example embodiments provided herein. Furthermore, advantageous background region balancing can be implemented in accordance with example embodiments not only between multiple images in a collection but also between an image and a background canvas such as a tinted page in a book.

In another example, a method of controlling photobook page-to-page transitions is provided. Photobooks that contain images shot over a period of time, e.g., several hours or more, and may have been taken with different background conditions. For example, certain images may be captured at an afternoon wedding that transitions into an evening party when additional images are captured. For these collections of images, an overall color or white balance will likely naturally vary as the lighting changes occurring over the course of a day that continue into hours of the evening. By gathering background statistics from every image in the collection individually, photographic images can be placed or ordered so that the color or white balance of the photos progresses smoothly from page to page.

In another example embodiment, video images, clips or cuts may be advantageously processed and enhanced. Individual frames from videos can be separated into foreground and background in a similar manner as still photos. Then, the balance correction or adjustment of the backgrounds of image frames can be altered depending on the context provided in the sequences of video frames. For example, when changing scenes (from indoors to outdoors, for example), differences between background image parameter values for indoor scenes and outdoor scenes or other significantly different scenes can be exaggerated or similar scene contexts may have difference between background image parameter values reduced or minimized by altering an amount of background adjustment or correction that is applied to one or more image parameters from over a number of frames at the end of one scene and also at the beginning of a following scene.

Several process steps that may be utilized in various combinations are described below. Some of the steps described below may be alternatives and entirely optional while certain steps may always be preferred in certain contexts.

### Determine Individual Background Statistics for Each Photo in a Collection

An example process may include isolating a portion of the top of an image that is only background content. In one implementation, for improved performance, search for regions in the periphery of the image. The process may include cropping the top part of the image to half-way to the top of the face rectangle. If the head extends too high, then the process may also include cropping lower into the image. The next step may include removing the entire head and hair.

In another implementation: the use of machine learning techniques like face, head, portrait or other object detection, salience detection or other semantic segmentation can be used to identify a main subject in a photo. Once a main subject is identified, the remaining portion of the image may be deemed to be background content in an example embodiment.

In a third example implementation: a separate reference background image may be captured, without a person or other foreground object in the frame, against a same or similar scenery as that which will be captured outside of foreground regions in all or a subset of the photos taken in a collection. All of the pixels in this entire reference image are background content based on the absence of any foreground object. Then, similarity matching techniques can be used to identify background areas within the collection of images that also include foreground objects by comparing one or more attributes of pixels, groups of pixels, image areas or image regions of each of the images with those of the reference background image. Areas with a high degree of mismatch with the reference background image may be tagged as foreground, undetermined or possibly foreground to be checked against a follow-on foreground matching algorithm.

Every photo taken during a shoot that involves capturing a collection of images that generally each include a foreground region that may be defined by its edge, periphery or boundary which may include a continuous series of adjacent pixels that either closes with itself or with the frame of the image. Outside of the edge, periphery or boundary of an identified foreground object will either be another foreground object or a region of background pixels. A foreground object can be defined in example embodiments as a region that is void of identified background pixels, e.g., an area of significant mismatch with the reference background image, just as in other example embodiments wherein background regions can be deemed to exist where there is no identified foreground object.

Any background regions within images of a collection that also include foreground objects may in certain example embodiments be subjected to application of image processing that either renders each background region pixel that images a same background location of an image the same increases collective harmonization, synchronization, normalization, unification, conformation, identification, collectivization, adherence to a common collective theme, deviance curtailment, and/or uniform or collective modification, to conform to, harmonize with, normalize to, that match the known background content from the reference image.

In another embodiment, the process may include finding background statistics of this background-only segment. These statistics may include a single image attribute or a combination of image attributes, such as:
a. Average brightness;
b. Brightness range, dynamic range, or standard deviation of brightness level;
c. Average hue or hue distribution;
d. Average saturation or saturation distribution;
e. Noise pattern;
f. Texture pattern;
g. Level of sharpness, focus or blur;
h. Lighting/gradient position;
i. Focus depth.
j. Red, green, and/or blue channel data—including histogram, data ranges, and distribution
k. Combinations of two or more of steps of (a) to (j).

Each photo will have unique background statistics. The variation of these statistics from image to image determines the amount and type of correction needed to bring the entire set into balance. Altering the background of the image will alter the background statistics.

### Determining Target Background Statistics for an Image Collection

The target background statistics may include one or more values, e.g., an average value and/or a calculated or predetermined value, that a background region in each individual image in a collection will be adjusted to match. These may include one or more of the same statistical variables that may have been gathered from many images in the collection (e.g., brightness, hue, sharpness, etc.). However, in this example, the statistical variables may be selected from a specific photo or determined algorithmically.

The target value of an image parameter for adjusting background regions to be exhibited uniformly within the collection can be determined automatically, or manually. Methods to determine the target background value automatically may include:
1. averaging values for all photos in the collection or a subset or subsampling thereof; or
2. averaging values for a collection N photos, wherein N can be a percentage (%) of the total photo count for the collection, or can be a fixed number large enough to gain statistical significance. These N different photos may be spaced uniformly with regard to a parameter such as time of capture or location within a sequence of images captured across the collection. For example, every even-numbered image, every 3^{rd} image, every 4^{th} image, etc., or in another example, the images may be selected as one or more sequences of captured images, such as the first N images, the middle N images, or the last N images, or the first, middle and last N/3 images; or
3. averaging values from one or more specific reference images. For example, a photo taken with no person in the image, or a single photo or a few reliably high quality photos that is or are carefully prepared by the photographer, or a high, medium or low-resolution preview and/or post-view image taken just before and/or just after, respectively, capturing each photographic image in the collection, or averaging values of a series of preview and/or post-view images.

Methods to determine the target background value manually may include one or more of the following steps:

First, an operator may manually select a specific image from a collection, such that the background statistical value, e.g., a mean, median or mode average value, for the background region of this one selected image could be used to determine the target background value; or

Second, an operator may manually select a specific image not from the collection. For example, an external sample image may be selected that is known or determined to exhibit an ideal background distribution and/or average statistical background value or an industry approved or company approved or customer approved or expert approved image or statistical value to select as a target value for adjusting background regions to uniformly exhibit within the collection.

Third, an operator may manually define values from known color and/or texture combinations; or

Fourth, an automatic adjustment of background regions of images within the collection may be performed after which the background regions may uniformly exhibit a target value that has been determined from any of the above methods or a suggested or learned calibration starting value. Then, an operator may manually adjust values of the image parameter for each background region within the collection of images to adjusted values that appear to better suit certain output preferences or requirements.

Once the target background statistical value or values is/are known, an image-specific adjustment can be calculated or determined from one or more differences between the target value or values and individual background statistical values for each image in the collection.

The average value and/or statistical distribution of the image parameter for the background regions of the images in the collection can each be compared with the target value and adjusted to match the target value. The collection of images would then uniformly exhibit background regions with target values or average values or distributions of the image parameter. The images in the collection may be individually automatically altered to generate a new collection of images that uniformly exhibit background regions having approximately a same or similar target value or may have a value that is in accordance with a preset relation to the target value or target distribution of the image parameter.

An approximate target background value to which, or to within a preset relation of which, each image within the collection may be approximately altered to generate a new collection of images including foreground objects against background regions may conform, harmonize, collectively identify, and/or render uniform, similar or approximately identical the multiple adjusted images that together form the new collection. The new collection will uniformly exhibit new background region statistics, e.g., having a significantly reduced standard deviation of the image parameter from the target value or average value. In an example embodiment, once the adjustment is applied to an image of the collection, the background region may have identically the target value and/or identically a target distribution and/or identically another target background statistic.

In an example, a collection of five images may have average brightness values, respectively, which are: 178, 179, 180, 181, 182 in arbitrary units. The target background statistics may include an average brightness of 180 based on the mean, median and mode averages for the five images in the collection are all 180. The starting standard deviation for the collection is (5/2)^{1/2} or about 1.58 and the standard deviation for the new collection after adjusting the average brightness of four of the images to 180 would be ideally reduced to 0 and the distribution would become a delta function. Thus, a correction of average brightness may be applied in an example embodiment to four of the five images in this example collection, such that after the correction, the newly measured or post-processing average brightness values for each of the five images in the processed collection is 180. This could be achieved by adding or subtracting the following amounts to the luminance channels of background pixels within the above five example images of, respectively, +2, +1, 0, −1, and −2.

In one example embodiment, brightness correction is only applied to the backgrounds of the images in a collection that vary from target background values, while the average brightness values of each of the persons in the foregrounds of the photos in the collection may be left unchanged. The foreground regions in a more general process may be processed separately in accordance with any conventional face detection and correction technique.

### Creating a Mask to Separate a Face Image from a Background Region

In an example embodiment, value thresholding may be applied to individual images in a collection based on one or more image parameters or imaging criteria such as one or more of hue, saturation, tone, chroma, texture, sharpness, or combination thereof.

Determining which image parameter or imaging criteria or combination of criteria to use may be determined by one or more of the following. First, the data layer or layers may be chosen whose background statistics are the most different from the background statistics of the entire photo. Second, the data layer may be chosen that has the narrowest data range and/or only has a single peak. Third, a user may manually select a different data layer to use.

Each of these methods would involve determining thresholding values by gathering statistics on the background-only portion of the image. Relevant statistics may include one or more of the following. First, a relevant statistic may include minimum and maximum values of data in each data layer. Second, relevant statistics may include standard deviation and average (mean, median and/or mode) values of the data in each data layer

### Cleaning the Mask

A background mask may be cleaned by removing islands and/or filling lakes on either side of a mask edge. One implementation will be to do so using morphological operations. “Islands” refer to areas wholly contained within foreground areas that are mistakenly included in the background mask, and these are seen as isolated black regions in the white foreground in the example schematic illustration provided at FIG. 2A which are removed in the cleaned mask that is schematically illustrated at FIG. 2B. “Lakes” are areas wholly contained in the background that are mistakenly included in the foreground. These are shown as white regions in the black background in the example illustrated at FIG. 2A which are removed in the cleaned mask that is schematically illustrated at FIG. 2B.

In an example embodiment, an edge of the mask may be refined. The edge defines the border between the foreground object and the background region of the digital image. This can be done with edge detection algorithms, or with machine learning tools, or can be operator-assisted (where a user clicks on areas in either the foreground or background to remove or include these areas in the masked region).

### Optionally, Applying a Gradient Mask

The correction or adjustment of a background region at the top of a portrait image is the most visually important. It is a large field of background and is visually the most obvious background area in the image. Segmentation at the bottom of the image is the most difficult, given shadows and other issues such as the complexity of the mask edges. So, in accordance with an example embodiment, a gradient may be applied to limit an amount of target background adjustment or correction that will be applied particularly nearer the bottom of the portrait image. The location that the gradient mask starts can be tuned to optimize the correction quality versus mask error visibility tradeoff, because a higher mask is more forgiving of mask errors, but corrects less of the image.

### Optionally, Blur or Soften the Mask

Even after automatic or manual mask cleaning, the selection of fine detail like individual strands of hair might still not be perfect. These imperfections can become obvious once image manipulation is applied only to the background of the image. A method to diminish the visual impact of these imperfections is provided in accordance with an example embodiment. The method may include applying a blur of a specific amount to gradually blend from the foreground object (which will remain uncorrected in certain embodiments) to the background region (which will be adjusted in the next step in this example embodiment). This blurring procedure can include a fixed-radius gaussian blur or a Lorentzian blur or an applied blur may be increased linearly with distance away from an edge or a center of a foreground object, or with the square or cube of the distance, or may be increased at any faster rate, or may be uniformly blurred, or a conventional or standard blurring operation may be applied to any or all of the background. This process can be improved upon by choosing a radius based on image content or location within the image (for example, use a larger radius when in an area with greater detail—like around fine hair). The blur can be modified to only apply to the background portion of the image, and thus the foreground region may be enlarged into the background area. In certain embodiments, pixel locations within the image that may have been previously selected as foreground regions may be blurred or altered to become included in the background.

### Applying a Bias or Adjustment to an Image Correction Parameter

When each image in a collection is ready to be altered by one or more image parameter value manipulations such that an area described by a background mask exactly matches a target statistic in certain example embodiments. However, there may be reasons to perform image manipulations that may approach but do not exactly achieve an exact match to the target value. Among such reasons, the following may be included.

First, a variation in the background statistics may be very large. For example, some backgrounds are very bright and some backgrounds are very dark, and thus large adjustments would be involved in adjusting these backgrounds to each uniformly exactly match the target value. In this situation, adjusting a very bright or very dark background might reveal flaws remaining in the background mask, which may include flaws that would not be visibly noticeable if smaller adjustments were made instead.

Second, a mask blurring operation may result in an intentionally imperfect background mask. Such imperfections as these can be more likely to become visible when making certain types of background adjustments, for example, hue adjustments.

A third reason may involve other variations in image content or operator preferences or requirements.

Thus, it may be desirable to achieve less than perfect matches on the backgrounds of every image. This could be achieved by allowing an adjustment of the image parameter to differ by a small deviation from the precisely correct background statistics for uniformly exactly matching the target background region value for the image parameter. For example: average brightness may be allowed to be within, e.g., five (5) pixel brightness increments of calculated values that would exactly match the values of the target background, or within a certain percentage range of the target in another example embodiment.

In another example embodiment, less dramatic changes may be applied to the brightest and darkest backgrounds in a collection, and thus imperfections in the background mask are less likely to be visible or unappealing. In this example embodiment, the photos in a collection that have the brightest and darkest backgrounds pre-processing will continue to have the brightest and darkest backgrounds post-processing, even though these photos may be significantly corrected to much more closely match the target background average brightness than the original images did and even though one or more of these brightest or darkest photos may be corrected by applying more darkening or brightening, respectively, compared with the backgrounds of other photos in the collection that may already have pre-processing average brightness values that more closely match the target background average value.

It may be desirable in certain contexts to apply a small adjustment amount of the image parameter in a correction of the foreground portion of an image in a collection, for example, when a background region of the same image is being significantly brightened. For example, if the correction to be applied to the background will brighten the background by 20%, then a brightness correction of 2%, or between 1%-3%, or up to 4% or 5% or 6% or 7% or 8% or 9% or 10% could be applied to the foreground object of the same image, or the foreground object of an image in a collection may be brightened or darkened by 5%, 10%, 15% or 20% or 25% of the amount of brightening or darkening, respectively, that is calculated for applying to the background to match the target value. This reduces the difference between the correction applied to the foreground and background (e.g., to between 14%-19% as opposed to 20%). Mask errors, if any, may be made less obvious or less apparent when brightness correction is applied to images in collections in accordance with one or more of these example embodiments.

It may be desirable in certain example embodiments to apply less than the entire correction or adjustment amounts which would be applied, respectively, to background regions within particular individual images of the multiple digital images in a collection to uniformly exactly achieve matches to a target background statistical average for one or more image parameters. From the previous example, instead of applying 20% brightness to the background, one could apply 18% or between 14%-19%.

In another example embodiment, applying brightening broadly to background pixels in an adjustment amount that is less than an amount calculated to uniformly match an average brightness of a background region of an individual image in a collection to a target background average brightness may be combined with application of a different amount, e.g., a smaller amount, of correction to adjust a statistical value of an image parameter in a foreground object. For example, the small amount of correction applied to the foreground may provide a 2% increase, or between 1%-10%, in average brightness, while a correction applied to the background may be 2%, or 1%-20%, less than the calculated correction amount for matching the target background average brightness value. So then in this example, the result would be a processed image in a collection wherein a relative difference between amounts of applied correction to the background and foreground components of the image would be only 16%, or 14%-19% as opposed to the 20% calculated to achieve an exact match with a target background average brightness correction.

Further, by allowing specific deviations in the image correction of background and/or foreground components of individual images in a collection, and optionally by using one or more or several other possible image parameters or image criteria to vary or determine or preset a range or other boundary based upon when and how much deviation may be preset to be automatically applied or allowed to be optionally applied post-capture, an operator can gain further control over presentations of entire sets or collections of images. Three example embodiments include the following.

First, a photobook that documents a wedding or a party or a meeting, whether in-person, online or virtual, or other gathering of people of any kind, can present photos that have, or are corrected to have, an identical or nearly identical background brightness in a collection of photos on two facing pages, while allowing for controlled differences in background brightness between photographs not disposed on facing pages or a same page of the photobook. Thus, in another example embodiment, images, or backgrounds of images, could be made darker and darker as photos are included which were taken at later and later times on the day of the event. For example, one brightness deviation from a target brightness may be used for backgrounds of images taken in the afternoon, and another for images taken in the early evening, and another for images taken at night. In example embodiments, deviations from target parameters may be applied to subsets of captured images in a collection taken at night with or without moonlight and/or starlight and/or city lights, and in other example embodiments, specific deviations from target values of image parameters may be applied to images captured at dusk and dawn.

Second, in addition to applying brightness correction, further example embodiments involve correction or control of other image parameters such as white balance or tint in collections of images. Thus in example embodiments, collections of images may be corrected to trend “warmer” by appearing more red or orange as the sun sets or as the sun rises, or images on pages in the middle of a photobook may rise to a peak in redness or warmth compared with the beginning pages of the book which may be more blue and cold, and/or images may trend bluer and cooler again as night descends such as may be provided on pages towards the end of the book.

Third, backgrounds of video frames from one clip can be adjusted to either better match or more obviously contrast with frames of a following scene.

### Adjust Image Backgrounds to Match a Target Background

Once the target background statistics are known, the background mask has been created and altered as desired or needed, and any desired, preferred, programmed, preset, automatic and/or manual per-image deviations from the ideal target to an image-specific target are determined for one or more image parameters of the individual images in a collection to actually achieve, the next step is to apply one or more image adjustment and/or correction routines or processes to adjust the background region of each individual image in a collection to uniformly match the target value or values. These routines or processes may include any number of the following steps.

A first possible step may include adjusting an average exposure, hue, and/or saturation value for the background region of each image in a collection so that each individual background in the collection, respectively, uniformly matches a target exposure value, a target hue value and/or a target saturation value.

A second possible step may include sharpening or blurring the background region of each image in the collection to uniformly match a target sharpness value.

A third possible step may include adding chroma (chrominance) and/or luma (luminance) noise to the background region of each image in the collection to uniformly match a target value of chroma noise and/or a target value of luma noise.

A fourth possible step may include applying a machine learning style transfer tool to transfer a target style to the background region of each image in the collection to uniformly match the target style.

### Illustrative Examples

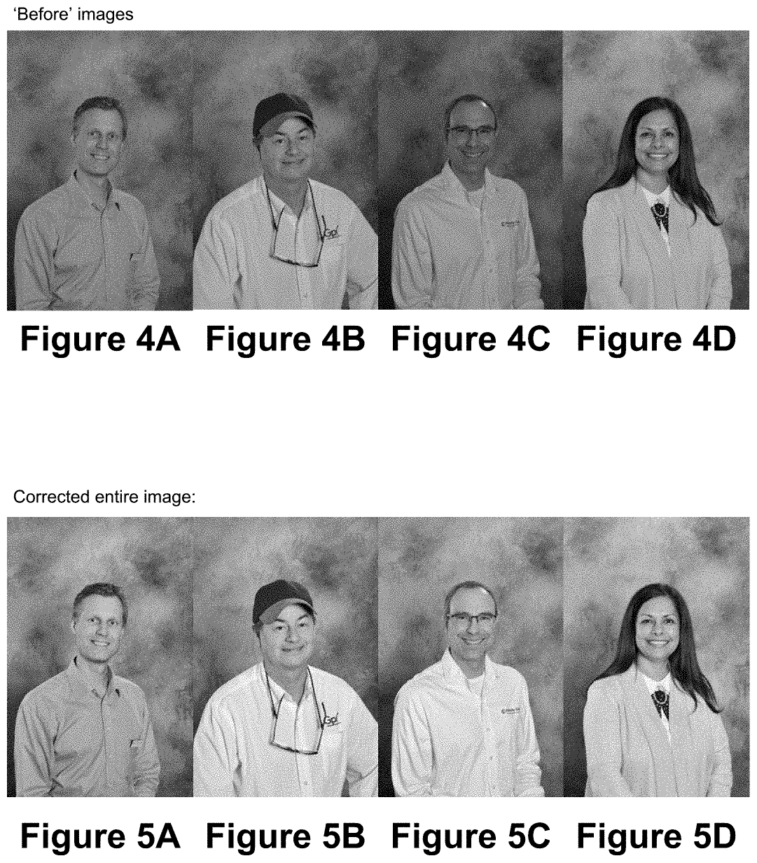

FIGS. 4A-4D illustrate a collection of four portrait images of four different persons whose faces and clothing are dark and differ in brightness and color against backgrounds that differ in brightness and color. FIGS. 4A-4D may be referred to as before images.

FIGS. 5A-5D illustrate the collection of images of FIGS. 4A-4D that have been adjusted to brighten the faces and clothing of the four photographed persons, while the backgrounds vary greatly in brightness and color. The four photographic images shown in FIG. 4A-4D have been independently corrected with Perfectly Clear software and the results are FIG. 5A-5D

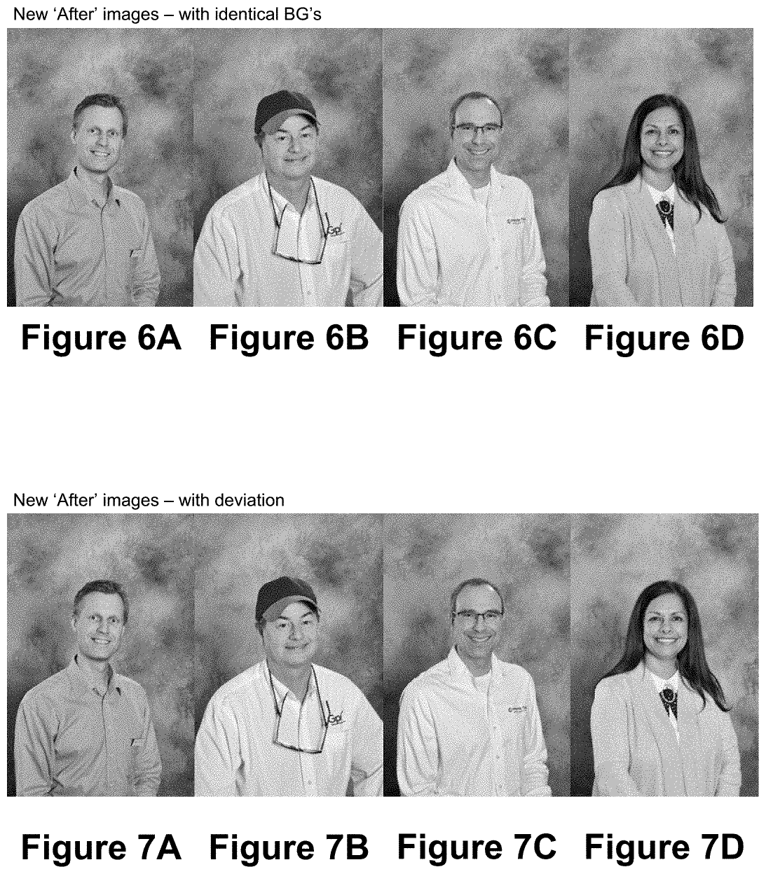

FIGS. 6A-6D illustrate the collection of images of FIGS. 5A-5D that have each been adjusted so that each background region matches the same or nearly the same target values of exposure, hue and saturation in accordance with an example embodiment. The set of FIGS. 6A-6D may be referred to as after images.

FIG. 7A-7D illustrate the collection of images of FIGS. 5A-5D that have each been adjusted so that differences in exposure, hue and saturation between each background region and target values have been reduced by smaller amounts than in FIGS. 6A-6D in accordance with another example embodiment. FIGS. 7A-7D nay be referred to as after images with planned, controlled and/or intentionally remaining and left-over deviations of background regions from the target values.

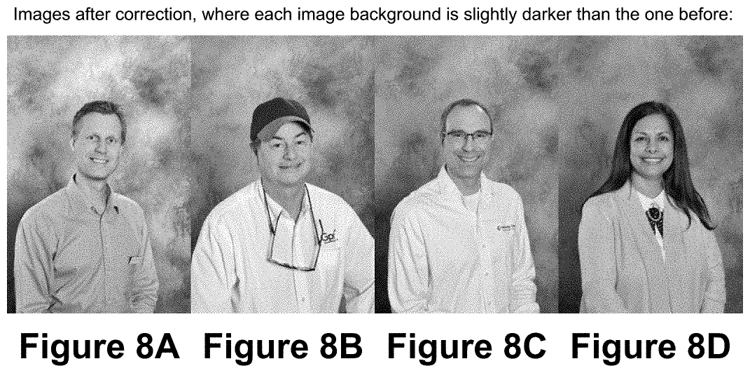

FIGS. 8A-8D illustrate the collection of images of FIGS. 7A-7D that have been adjusted so that the backgrounds are progressively darkened from FIG. 8A to FIG. 8B to FIG. 8C to FIG. 8D in accordance with another example embodiment.

### Alternative Embodiments

A normalization process may be applied to background regions and/or foreground objects in digital images that make up a collection. Normalization may be applied to make the average colors, the distribution of colors, and/or the patterning of colors appearing in background regions of images in a collection uniformly match one or more same or similar approximate target values. Averaging of color may be calculated across several images in a collection in an example embodiment.

In example embodiments, image segmentation may be performed in batches. Artificial intelligence or AI may be used to perform foreground/background segmentation and/or to segment a detected face or other object from a background region of a digital image.

The example embodiments described herein may be applied to collections of multiple individual still images and/or to multiple frames of video images.

In certain example embodiments, a determination may be made not to perform white balancing.

Foreground objects and/or background regions as objects may be detected and/or tracked across multiple still images in a collection and/or across multiple frames of video images.

Within each frame wherein a foreground object and/or a background region as an object is detected, frame by frame and/or still image after still image matching with target values, e.g., average values for the collection, with or without variances, may be performed so that foreground objects and/or background regions as objects within multiple digital images in a collection may in example embodiments approximately uniformly match target values and/or identify, conform, harmonize, and/or render together collectively.

A method in accordance with an example embodiment may include selecting multiple objects in video frames and color correcting and/or tone correcting certain of those objects to avoid jumps in color.

### Additional Embodiments

Another example embodiment may involve using background statistics to segment a collection of photos into sub-collections. For example, an entire school of 2000 children might have photos taken and all photos make up an entire collection. However, not all 2000 photos will be presented on a single pair of facing pages, where deviations in backgrounds would be most noticeable. So, sub-collections can be automatically created by grouping photos with similar background statistics for presentation on facing pages or on same pages.

Combinations of mask and color segmentations may be based on comparing background region content and foreground object content. For example, instead of altering the brightness of the entire background of a photo in some embodiments, e.g., using an entire background mask, only certain portions of background regions that are predominantly red, blue, or green, or combinations thereof, are altered in an example embodiment.

Another example method includes determining what portion of an image is background based on removing the areas that are not background. Thus, a background region may be defined in certain embodiments as all portions of an image that do not contain foreground pixels, such as a student or a face of a student in a class photo.

Another embodiment includes a two-stage process wherein background balancing is applied before other image correction steps to achieve an enhanced final product. One or more later image correction steps may be improved as a result of an early process of background balancing. For example, green screen images may be taken with a person placed in front of a solid green background. The final output image may be achieved by replacing the green background with a digital background. Background balancing may be applied to a set of these greenscreen images such that all the green areas are rendered as similar as possible, in turn making the green background removal simpler and more successful.

Another embodiment involves adding a post processing stage such as blurring and/or sharpening of one or more background regions within a collection of images.

While an exemplary drawings and specific embodiments of the present invention have been described and illustrated, it is to be understood that that the scope of the present invention is not to be limited to the particular example embodiments discussed. Thus, the embodiments shall be regarded as illustrative rather than restrictive, and it should be understood that variations may be made in those embodiments by workers skilled in the arts without departing from the scope of the present invention.

In addition, in methods that may be performed according to preferred embodiments herein and that may have been described above, the operations have been described in selected typographical sequences. However, the sequences have been selected and so ordered for typographical convenience and are not intended to imply any particular order for performing the operations, except for those where a particular order may be expressly set forth or where those of ordinary skill in the art may deem a particular order to be necessary.

A group of items linked with the conjunction “and” in the above specification should not be read as requiring that each and every one of those items be present in the grouping in accordance with all embodiments of that grouping, as various embodiments will have one or more of those elements replaced with one or more others. Furthermore, although items, elements or components of the invention may be described or claimed in the singular, the plural is contemplated to be within the scope thereof unless limitation to the singular is explicitly stated or clearly understood as necessary by those of ordinary skill in the art.

The presence of broadening words and phrases such as “one or more,” “at least,” “but not limited to” or other such as phrases in some instances shall not be read to mean that the narrower case is intended or required in instances where such broadening phrases may be absent. The use of the term “assembly” does not imply that the components or functionality described or claimed as part of the assembly are all configured in a common package. Indeed, any or all of the various components of an assembly may be combined in a single package or separately maintained and may further be manufactured, assembled or distributed at or through multiple locations.

Additionally, the various embodiments set forth herein are described in terms of exemplary schematic diagrams and other illustrations. As will be apparent to one of ordinary skill in the art after reading this document, the illustrated embodiments and their various alternatives may be implemented without confinement to the illustrated examples. For example, schematic diagrams and their accompanying description should not be construed as mandating a particular architecture or configuration.

In addition, all references cited herein, as well as the background, abstract and brief description of the drawings, are all incorporated by reference into the detailed description of the embodiments as disclosing alternative embodiments. Several embodiments have been described herein of example image processing techniques and schematically illustrated in the drawings. The following US patents are incorporated by reference as disclosing alternative image processing methods and devices that may be combined with processes described herein to form alternative processes that are within the spirit and scope of the invention:

U.S. Pat. Nos. 7,269,292, 7,317,815, 7,469,071, 7,564,994, 7,620,218, 7,634,109, 7,680,342, 7,692,696, 7,693,311, 7,796,816, 7,796,822, 7,868,922, 7,912,285, 7,957,597, 8,055,067, 8,170,350, 8,175,385, 8,212,897, 8,339,462, 8,358,841, 8,363,908, 8,532,380, 9,117,282, 9,684,966, and 2006/0285754 are all incorporated by reference.

What is claimed is:

1. A method of generating a collection of digital images including foreground objects against background regions that are each adjusted to uniformly exhibit approximately an average target value of an image parameter, comprising:
a. dividing each image in a first collection of multiple images into foreground and background regions;
b. determining a statistical value of an image parameter for the background region of each image in said first collection of multiple images;
c. determining a target value of the image parameter;
d. generating a second collection of multiple images including adjusting the background region of each image in said first collection in accordance with a preset relation to the target value of said image parameter; and
e. assembling a presentation of said second collection comprising said multiple images with adjusted background regions uniformly exhibiting a narrowed range of values around the target value of the image parameter.

2. One or more non-transitory processor-readable storage devices having code embedded therein for programming a processor to perform a method of generating a collection of digital images of different foreground objects against background regions adjusted from captured image data for uniformity of an image parameter, wherein the method comprises:
a. dividing each image in a first collection of multiple images into foreground and background regions;
b. determining a statistical value of an image parameter for the background region of each image in said first collection of multiple images;
c. determining a target value of the image parameter;
d. generating a second collection of multiple images including adjusting the background region of each image in said first collection in accordance with a preset relation to the target value of said image parameter; and
e. assembling a presentation of said second collection comprising said multiple images with adjusted background regions uniformly approximately exhibiting said preset relation to the target value of the image parameter.

3. The one or more storage devices of claim 2, wherein the dividing comprises creating a background mask that only includes pixels with values of a same or different image parameter above or below a threshold value.

4. The one or more storage devices of claim 3, wherein the creating further comprises cleaning the background mask by removing island regions or filling lake regions or both on respective sides of a mask edge.

5. The one or more storage devices of claim 2, wherein the dividing comprises detecting one or more foreground objects within each image in said first collection and designating any non-foreground object pixels as forming said background region.

6. The one or more storage devices of claim 2, wherein the method further comprises increasing or decreasing said adjusting the background region of said each image in said first collection in accordance with said preset relation to said target value by applying a gradient mask in a certain direction within the image plane.

7. The one or more storage devices of claim 2, wherein the preset relation comprises an exact match.

8. The one or more storage devices of claim 2, wherein the adjusting in accordance with said preset relation comprises reducing an initial difference between values of the background region and said target value to within a predetermined percentage of said initial difference.

9. The one or more storage devices of claim 2, wherein the adjusting in accordance with said preset relation comprises reducing an initial difference between values of the background region and said target value to within a predetermined range of smaller differences.

10. The one or more storage devices of claim 2, wherein the adjusting in accordance with said preset relation comprises reducing an initial difference between values of the background region and said target value by a predetermined percentage of said initial difference.

11. The one or more storage devices of claim 2, wherein the method further comprises adjusting the foreground region of each image in said collection by a fraction of an amount of the adjusting of said background region.

12. The one or more storage devices of claim 2, wherein said collection of multiple images comprises images processed by applying image correction processing to individual images independent of other images within the collection.

13. The one or more storage devices of claim 2, wherein said determining said target value comprises determining an average value of said image parameter for all or a sub-sampling of the background regions of said collection.

14. The one or more storage devices of claim 13, wherein said determining said target value further comprises setting the target value as said average value or an adjusted value based on said average value.

15. The one or more storage devices of claim 2, further comprising applying blurring or smoothing or both to background regions of images in the collection that are near a mask edge.

16. The one or more storage devices of claim 2, wherein said statistical value of said image parameter comprises average brightness, average brightness range, average dynamic range, standard deviation from average brightness, average hue, hue distribution, average saturation, saturation distribution, noise pattern, texture pattern, average sharpness, average focus, average blur, average lighting gradient, lighting distribution, average dynamic range, or specific color channel subsets thereof, or combinations thereof.

17. The one or more storage devices of claim 2, wherein said statistical value of said image parameter comprises average relational intensities of multiple color channels and wherein said adjusting said background regions excludes at least one of said multiple color channels.

18. The one or more storage devices of claim 2, wherein said generating said second collection comprises adjusting said background regions in accordance with preset relations to target values of multiple image parameters.

19. The one or more storage devices of claim 18, wherein the multiple image parameters comprise average exposure, hue and saturation.

20. A camera enabled digital device, comprising a device housing, a lens, an image sensor disposed at a focal plane of the lens, a processor and one or more non-transitory processor-readable storage devices having code embedded therein for programming the processor to perform a method of generating a collection of digital images of different foreground objects against background regions adjusted from captured image data for uniformity of an image parameter, wherein the method comprises:
a. capturing a first collection of multiple images;
b. dividing each image in the first collection of multiple images into foreground and background regions;
c. determining a statistical value of an image parameter for the background region of each image in said first collection of multiple images;
d. determining a target value of the image parameter;
e. generating a second collection of multiple images including adjusting the background region of each image in said first collection in accordance with a preset relation to the target value of said image parameter; and
f. assembling a presentation of said second collection comprising said multiple images with adjusted background regions uniformly exhibiting a narrowed range of values around the target value of the image parameter.
